(19) United States
(12) Patent Application Publication
(10) Pub. No.: US 2009/0190719 A1
(43) Pub. Date: Jul. 30, 2009

(54) X-RAY SOURCE APPARATUS, COMPUTER TOMOGRAPHY APPARATUS, AND METHOD OF OPERATING AN X-RAY SOURCE APPARATUS

(75) Inventors: Hans Barschdorf, Dassendorf (DE); Jens-Peter Schlomka, Hamburg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/576,548

(22) PCT Filed: Oct. 5, 2005
(86) PCT No.: PCT/IB2005/053272

§ 371 Date: Apr. 3, 2007

(30) Foreign Application Priority Data
Oct. 8, 2004 (GB) 0422374.9

(51) Int. Cl. H01J 35/30

(52) U.S. Cl. 378/137

(57) ABSTRACT

An X-ray source apparatus (100) comprises a cathode (101), comprises an electron beam deflection means including one or more electron beam deflection elements (103) and comprises an anode (102). The cathode (101) is adapted to emit an electron beam (104) towards the electron beam deflection means. The electron beam deflection means is adapted to deflect an electron beam (104) coming from the cathode (101) to a selectable part (110) of the anode (102), wherein the selectable part (110) of the anode (102) is selectable to by activating a single one of the one or more electron beam deflection elements (103), with the single activated electron beam deflection element (103) being arranged at a variable position along a propagation path of the electron beam (104) coming from the cathode, (101) such that the electron beam (104) is deflected to the selectable part (110) of the anode (102). The anode (102) is adapted to generate an X-ray beam (104) when being irradiated by an electron beam (104) deflected by the electron beam deflection means.

The invention relates to the field of X-ray sources. In particular, the invention relates to an X-ray source apparatus, to a computer tomography apparatus, and a to method of operating an X-ray source apparatus.

Over the past several years, X-ray baggage inspections have evolved from simple X-ray imaging systems that were completely dependent on an interaction by an operator to more sophisticated automatic systems that can automatically recognize certain types of materials and trigger an alarm in the presence of dangerous materials. An inspection system has employed an X-ray radiation source for emitting X-rays which are transmitted through or scattered from the examined package to a detector.

For X-ray inspection of objects, a suitable X-ray source apparatus is necessary. A conventional X-ray source apparatus comprises a cathode for emitting an electron beam which is accelerated to an anode in which the accelerated electron beam generates X-rays which are emitted onto an object of interest.

However, for X-ray inspection of large objects, the opening angle of a conventional X-ray source is not wide enough to cover the whole object. Therefore, a scanning movement of the object or of the X-ray tube is necessary.

In other applications, e.g. baggage inspection (see U.S. Pat. No. 6,693,988 B2), only a small part of the beam (a pencil beam or a cone beam) has to be collimated. To cover the whole object, the source and/or the detector have to be moved.

EP 0,024,325 discloses an X-ray source for tomographic applications which focuses an electronic beam on an arcuate anode ring using a fixed bending coil for deflecting an electron beam. By particularly selecting the deflection parameters, an electron beam is deflected in such a manner to impinge on one particular of different anode targets so as to produce an X-ray fan beam in a particular plane. However, the system of EP 0,024,325 is inflexible and has drawbacks when scanning a large anode.

U.S. Pat. No. 5,490,193 discloses an X-ray computer tomography (CT) system deflecting a predetermined electron beam generated by an electron gun using a plurality of deflecting elements arranged along a circle. The electron beam is deflected to a circular arc form trajectory by a uniform magnetic field generated by the plurality of deflector elements and, when the direction of the current to be passed through deflectors is reversed at a certain position, the electron beam on the arc form trajectory is deflected and irradiates an anode target. However, the X-ray CT system according to U.S. Pat. No. 5,490,193 is very complicated, since a large number of continuously activated deflecting elements along a circular path are required and need to be controlled in a complex manner. Thus, U.S. Pat. No. 5,490,193 describes a CT application according to which an electron beam has to be forced to an arc and is then deflected to the anode.

There is thus a desire to provide an X-ray source apparatus capable of producing an X-ray beam which is spatially controllable with high accuracy and with reasonable effort.

An X-ray source apparatus according to one aspect of the present invention comprises a cathode, comprises an electron beam deflection means including one or more electron beam deflection elements, and comprises an anode. The cathode is adapted to emit an electron beam towards the electron beam deflection means. The electron beam deflection means is adapted to deflect an electron beam coming from the cathode to a selectable part of the anode, wherein the selectable part of the anode is selectable by activating a single one of the one or more electron beam deflection elements, with the single activated electron beam deflection element being arranged at a variable position along a propagation path of the electron beam coming from the cathode, such that the electron beam is deflected to the selectable part of the anode. The anode is adapted to generate an X-ray beam when being irradiated by an electron beam deflected by the electron beam deflection means.

In another aspect of the present invention, a computer tomography apparatus for examination of an object of interest is provided, the computer tomography apparatus comprising an X-ray source apparatus with the above-mentioned features, and a scatter radiation detector for receiving X-rays scattered by the object of interest.

In yet a further aspect of the present invention, there is provided a method of operating an X-ray source apparatus, comprising the steps of emitting an electron beam towards an electron beam deflection means which includes one or more electron beam deflection elements. The electron beam is deflected by the electron beam deflection means to a selective part of an anode, wherein the selected part of the anode is selected by activating a single one of the one or more electron beam deflection elements, with the single activated electron beam deflection element being arranged at a variable position along a propagation path of the emitted electron beam such that the electron beam is deflected to the selectable part of the anode. According to the method, an X-ray beam is generated by irradiating the anode by an electron beam deflected by the electron beam deflection means.

The characteristic features according to the above aspects of the present invention have particularly the advantage that only a single electron deflection element needs to be activated (for example by applying an electric current to a coil) to cause a (linear) electron beam coming from the cathode to be deflected to a selectable part of the anode (for example as a consequence of a magnetic field which is produced by a coil through which a current flows and which thus exerts a force on the electron beam for deflecting the same). Therefore, it becomes possible, by activating only one deflection element, to choose a particular part of the anode which is to be impinged by the electron beam to produce X-rays to be emitted at a desired location. The position of the activated deflection element is variably controllable along the preferably linear propagation path of the electron beam emitted from the cathode.

According to one embodiment of the present invention, there is provided a single electron beam deflection element (for example a coil) which is moved along a propagation path of the electron beam coming from the cathode and which is variably brought to such a position that, when the electron beam is deflected by the electron beam deflection element, the deflected electron beam automatically impinges upon the desired portion of the (long) anode to generate an X-ray beam at a desired position. The provision of a single shiftable electron beam deflection element minimizes the number of components and thus the costs for manufacturing the apparatus.

According to another embodiment of the present invention, a plurality of electron beam deflection elements are provided along the propagation path of the X-ray beam originating from the cathode, wherein one particular electron beam deflection element is activated (for instance by applying an electric current to a coil as an example for an electron beam deflection element), wherein only the activated electron beam deflection element (and not the remaining non-activated electron beam deflection elements) generates a force effecting the electronic beam to force the electronic beam to be deflected to leave the propagation path and to impinge upon a particular portion of an anode. Thus, a plurality of electron beam deflection elements may be aligned along the propagation path, and only one of the electron beam deflection elements at a time is activated to select this electron beam deflection element and therefore to define the portion of the anode to be impinged.

According to this configuration, the electron beam deflection elements can be provided in a static manner, that is at fixed positions and thus unmovable, so that the number of moving parts may be minimised in the apparatus.

In another embodiment, instead of mechanically moving the X-ray tube, there is provided an X-ray tube with a large anode and a steerable electron beam, so that the electron beam will effectively perform the scanning movement. Design parameters such as for example the size of the anode, and hence the scanning amplitude, are hence flexible giving designers much freedom. The focus and deflection angle can be established in the same way as in an existing X-ray tube. In yet another configuration, an unaccelerated electron beam may fly parallel to the anode and is deflected towards it at one or more desired positions. The electron beam flying parallel to the anode results in a very compact size of the X-ray tube. The anode and an aperture (between the cathode and the electron beam deflection element) may lie on an electrical ground potential. A high negative voltage may be applied to the cathode. The electron beam is emitted and may be focused by usual focusing elements and is then accelerated towards the aperture, which usually lies at ground potential. The electron beam may pass through a hole in the aperture and enters the space behind, where no more acceleration needs to take place. Hence the requirement for an electrical field between the electron beam and the anode in this space necessary is reduced or eliminated.

There are several ways in which the electron beam may be deflected towards the anode, and hence the electron beam deflection elements may be realized accordingly.

In one realization of the deflection of the electron beam, there is provided a magnetic coil outside of a casing of the tube the coil generating a constant magnetic field, and wherein the coil can be moved parallel to the anode to define the focal spot position on the anode.

In another realization of the deflection of the electron beam, avoiding any mechanical movement, several coils can be placed outside the tube and can be arranged along a propagation path of the electron beam, the coils being switched on and off periodically. A switched on coil may represent the activated electron beam deflection element, whereas the switched off coils may represent the deactivated electron beam deflection elements. By changing the current of each individual coil, the focal spot can be moved continuously along the extended anode, since this varies the position of the only activated coil without the necessity of moving a coil.

According to the previously described embodiments for the electron beam deflection elements, magnetic coils are used which generate a magnetic field which has an influence on the electrons, thus deflecting the electrons from the cathode to the anode. As an alternative to the use of magnetic field generation means, an electric field generating means may be used which generate an electric force on the electron beam. For example, two opposing plates of a capacitor can be arranged inside or outside a casing of the X-ray tube to generate an electric field which causes the electron beam to be deflected away from the propagation path towards the anode.

Thus, electric and/or magnetic fields may be used to define the spot size and the position of the electron beam on the anode target.

The preferably linear X-ray source is particularly appropriate for industrial applications frequently requiring linear movements of an X-ray source. The invention benefits from the fact that the electron beam, after having entered a field free space behind an aperture which may be located between the cathode and the electron beam deflection element(s), flies parallel to the anode without the need of any electrical or magnetic steering, except for focusing purposes. Only the deflection to the focal spot on the anode has to be established.

This can be performed with moving magnetic coils outside the vacuum space of the tube. This option gives the advantage that the detector can be mechanically coupled to the focal spot.

For minimising the requirement for moving parts, a plurality of electrically switched coils may be used.

Steering electron beams by electrical/magnetic fields may be combined, with a simple array in which only a single deflection element needs to be activated at a particular point of time/at a particular operation mode. Preferably, a linear geometry of the apparatus may be used, which is a particularly suitable geometry for baggage scanning or industrial applications when large areas have to be irradiated. A further advantage of the linear geometry is to avoid additional steering components.

Scanning an electron beam onto the anode by the use of electrical/magnetic fields represents a significant improvement in this linear configuration. Furthermore, owing to the invention, the use of an external mechanically moving coil is provided as an option.

Thus, in aspect of the present invention there is provided an X-ray tube with an elongated anode and a steerable electron beam which can perform a scanning movement over the surface of the anode. The electron beam may fly linearly and parallel to the anode and may be deflected towards the anode by a moving magnetic field. This results in a scanning X-ray tube.

Exemplary technical fields, in which the present invention may be applied advantageously include baggage inspection, medical applications, material testing, and material science. An improved image quality and a reduced amount of calculations in combination with a low effort may be achieved. Also, the invention can be applied in the field of heart scanning to detect heart diseases.

A particular advantage of apparatus according to an aspect of the invention lies in the fact that the elongated anode is scanned by the electron beam in a fast manner. Thus, the power of the electron beam is “smeared” out along the length of the anode, allowing dissipation of generated heat in an improved manner. Thus, the power introduced in the system may be increased, increasing the intensity of the generated X-ray beam (see Osterkamp formula).

Referring to the dependent claims, further preferred embodiments of the invention will be described in the following.

Next, preferred embodiments of X-ray source apparatus according to the present invention will be described. These embodiments may also be applied to computer tomography apparatus according to the present invention and for methods of operating an X-ray source apparatus in accordance with the present invention.

At least one of the one or more electron beam deflection elements may be adapted to be movable along the propagation path of the electron beam coming from the cathode. According to this embodiment, the electron beam deflection element can be moved along or parallel to the beam propagation to such an extent and to such a position that the beam is deflected at such a position that it impinges the anode at a predetermined position. Thus, by moving the electron beam deflection element(s), the region of impingement of the electron beam to the anode and thus the region of generation of X-rays can be adjusted with high accuracy.

Alternatively, the electron beam deflection means may include a plurality of electron beam deflection elements arranged at different fixed positions along the propagation path of the electron beam coming from the cathode, such that the selectable part of the anode is selectable by activating a single one of the plurality of electron beam deflection elements arranged at such a position along the propagation path of the electron beam coming from the cathode, and hence the electron beam is deflected to the selectable part of the anode.

According to this embodiment, a plurality of electron beam deflecting elements are provided, wherein only an appropriately positioned one of the electron beam deflection elements is activated to deflect an electron beam at a defined position. This static solution does not require any movable electron beam deflection elements and uses the effect that, by arranging a plurality of electron beam deflection elements along the propagation path, there is always one electron beam deflection element which is located at a suitable position so that the electron beam impinges the anode at a desired position.

Thus, the plurality of electron beam deflection elements may be provided unmovable, that is spatially fixed, at different positions along the propagation path of the electron beam coming from the electrode. According to this embodiment, no moving parts are required. In contradiction to this, nevertheless a spatial scan of the anode is however enabled. Thus, an X-ray beam can be produced which scans the entire length of the anode.

The electron beam deflection means may be adapted to deflect an electron beam coming from the cathode to a selectable part of the anode by a deflection angle of essentially 90°. Consequently, the propagation path between the cathode and the electron beam deflection means on the one hand and the electron deflection means and the anode on the other hand may be oriented perpendicular, ensuring that no part of the electron beam impinges on an object located behind the anode.

At least one of the at least one electron beam deflection elements may be a coil, i.e. a magnetic coil for producing a magnetic field. An electric current flowing in such a coil generates a Lorenz force on the electrically charged electron beam having such an orientation that electrons propagating vertically with respect to a coil axis are deflected perpendicular to their propagation direction and perpendicular to the coil axis.

However, alternatives to a coil for an electron beam deflection element are possible, for instance any other magnetic field generating device which is adapted such that it generates a magnetic field to deflect an electron beam in a desired manner and direction. Moreover, an electric field generating means can be used to generate a electric field having a field component perpendicular to the propagation path of the electron beam. For instance, two capacitor plates may be used between which an electrical voltage is applied, which will force an electron beam to be deflected towards the positively charged capacitor plate. Furthermore, a negatively charged plate which is tilted with respect to the incident electron beam can be used to deflect the electron beam, due to an electrical force.

An axis of a coil as an electron beam deflection element may be oriented perpendicular to a plane established by the propagation path of the electron beam coming from the cathode and by a propagation path of the electron beam between the electron beam deflection means and the cathode.

The X-ray source apparatus may be adapted such that the propagation path of the electron beam between the cathode and the activated electron beam deflection element is essentially linear. In such a configuration, it is not necessary to provide and control any further deflection means, since no further steering of the electron beam is necessary.

Further, the X-ray source apparatus may be adapted such that the propagation path of the electron beam between the cathode and the activated electron beam deflection element is essentially parallel to an alignment direction along which different selectable portions of the anode are arranged. According to this embodiment, an elongated anode can be provided parallel to the propagation path of the incident electron beam.

Moreover, the X-ray source apparatus may comprise an aperture between the cathode and the electron beam deflection means. Such an aperture element may be used in an advantageous manner to collimate the electron beam emitted by the cathode ensuring an accurate deflection of a parallel electron beam.

Further, a supply voltage may be provided which is adapted to bring the cathode to a first electric potential and to bring the anode to a second electric potential, the first electric potential being negative compared to the second electric potential. Thus, an electric voltage can be generated to force the electrons to move from the cathode towards the anode.

The X-ray source apparatus may comprise a casing in which the cathode and the anode may be located, wherein at least a part of the electron beam deflection means may be provided outside the casing. Particularly, the electron beam deflection means may be positioned outside the casing, wherein the space inside the casing is preferably evacuated, that is brought into a vacuum state. By taking this measure, the number of components which need to be provided inside the vacuum chamber can be advantageously reduced. Since it is particularly difficult to arrange moving parts inside an evacuated casing, the configuration with the coils being located outside the casing allows a simplified manufacture and operation of the apparatus.

The X-ray source apparatus may comprise an electron beam manipulating element arranged between the cathode and the electron beam deflection means, the electron beam manipulating element being arranged such that the propagation path of the electron beam coming from the cathode is slightly tilted against an alignment direction along which different selectable portions of the anode are arranged. In other words, a further coil can be provided which slightly diffracts the electron beam from a direction parallel to the anode, so that the manipulating element (which is realizable as a coil, for instance) can function together with the activated electron beam deflection elements to accurately define a position of the electron beam on the anode.

Next, an embodiment of computer tomography apparatus in accordance with an aspect of the present invention will be described. This embodiment comprises X-ray source apparatus and a method of operating said X-ray source apparatus in accordance with aspects of the present invention.

Accordingly, there is provided computer tomography apparatus configured as one of the group consisting of a baggage inspection apparatus, a medical application apparatus, a material testing apparatus and a material science analysis apparatus.

The aspects defined above and further aspects of the invention are apparent from the examples of embodiment to be described hereinafter and are explained with reference to these examples of embodiment.

The invention will be described in more detail hereinafter with reference to examples of embodiment but to which the invention is not limited.

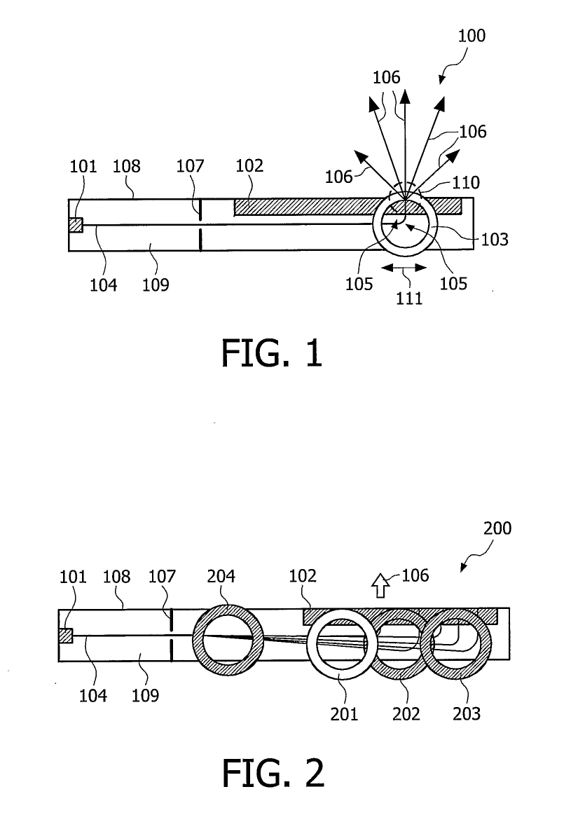

FIG. 1 shows an X-ray source apparatus according to a first embodiment of the invention,

FIG. 2 shows an X-ray source apparatus according to a second embodiment of the invention,

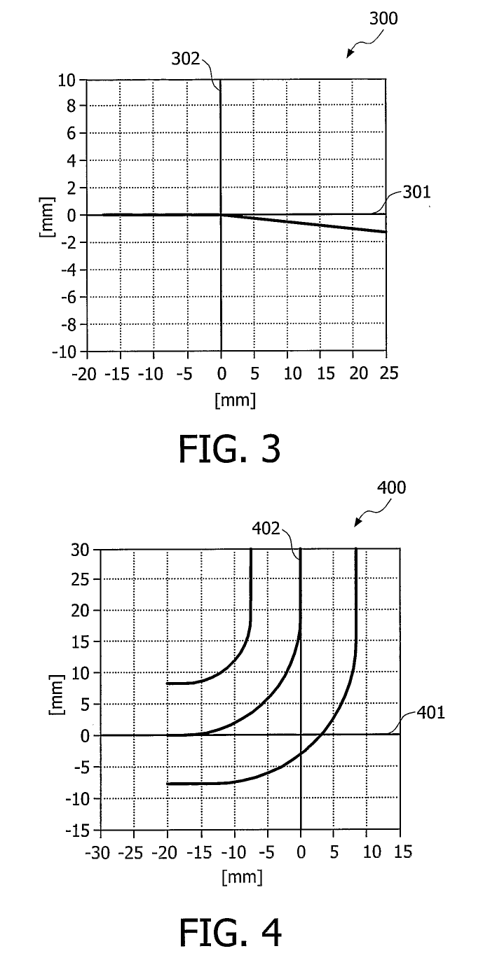

FIG. 3 and FIG. 4 show diagrams illustrating the function of the X-ray source apparatus of the invention,

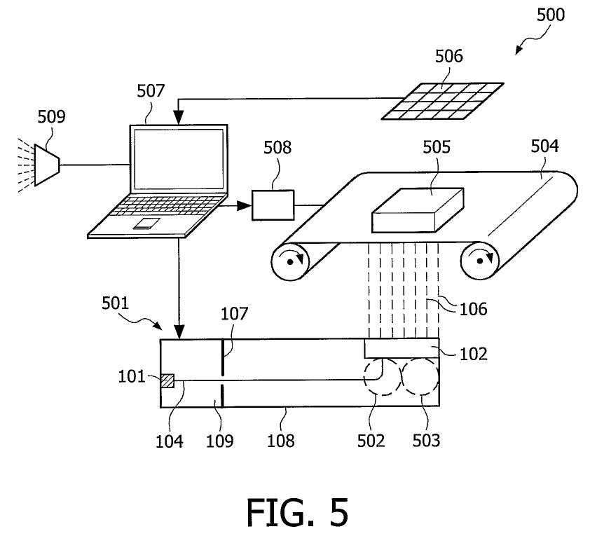

FIG. 5 shows a baggage inspection computer tomography apparatus according to a preferred embodiment of the invention.

The illustration in the drawing is schematically. In different drawings, similar or identical elements are provided with the same reference signs.

In the following, referring to FIG. 1, an X-ray source apparatus 100 according to a first embodiment of the invention will be described in detail.

FIG. 1 shows an X-ray source apparatus 100 comprising a cathode 101, a magnetic coil 103 with a coil access perpendicular to the paper plane of FIG. 1, the magnetic coil 103 forming a single electron beam deflection element of an electron beam deflection means, and comprising a tungsten anode 102. The cathode 101 is adapted to emit an electron beam 104 towards the magnetic coil 103. An electric current of an adjustable direction and of an adjustable strength is applied to the magnetic coil 103 to generate a magnetic field in a direction perpendicular to the paper plane of FIG. 1 inside the coil 103 and in a sufficient close vicinity of the coil 103. With such an activating electric current flowing through the magnetic coil 103, the magnetic field generated by the magnetic coil 103 deflects the electron beam 104 coming from the cathode 101 to a selected anode portion 110 of the anode 102 selected by activating the single magnetic coil 103 by applying the activation current.

As can be seen in FIG. 1, the single activated magnetic coil 103 is arranged at a position along a propagation path of the incident electron beam 104 such that the electron beam 104 is deflected to the selected anode portion 110 of the tungsten anode 102. The tungsten anode 102 is adapted to generate an X-ray beam 106 when being irradiated by an electron beam 104 deflected by the electron beam deflection means, namely the magnetic coil 103.

FIG. 1 shows a deflection area 105 in which the electron beam 104 is bended from an incident direction which is, according to FIG. 1, essentially horizontal, to a deflection direction which is, according to FIG. 1, essentially vertical. The force to bend the electron beam 104 is generated by the coil 103 in which an electric current flows to produce a magnetic field perpendicular to the plane direction of FIG. 1.

As indicated by a moving direction arrow 111, the magnetic coil 103 is provided shiftable along the propagation path of the electron beam 104 coming from the cathode 101, i.e. is capable of being moved or shifted in a horizontal direction according to FIG. 1. Thus, the selected anode portion 110 at which the X-rays 106 are generated can be selected by moving the coil 103. The magnetic coil 103 which is arranged outside the casing 108 (the inside of which being evacuated) can be moved along a direction 111 parallel to the elongated anode 102 to define a respective focal spot position on the anode 102.

As can be seen in FIG. 1, the movable coil 103 is adapted to deflect an electron beam 104 coming from the cathode 101 to the selectable part of the anode 110 by a deflection angle of 90°. An axis of the magnetic coil 103 is oriented perpendicular to the paper plane of FIG. 1, i.e. a plane established by the propagation path of the incident electron beam 104 and by a propagation path of the deflected electron beam 104.

The propagation path of the electron beam 104 coming from the cathode 101 is linear. Thus, no deflecting elements apart from the movable magnetic coil 103 need to be provided. An aperture 107 is arranged between the cathode 101 and the movable magnetic coil 103. A voltage supply (not shown in FIG. 1) is provided to bring the cathode 101 to a first electric potential and to bring the tungsten anode 102 and the aperture 107 to a second electric potential (e.g. the ground potential), the first electric potential being negative compared to the second electric potential. A high negative voltage may be applied to the cathode 101. The electron beam 104 is emitted and may be focused by usual focusing elements (not shown) and is then accelerated towards the aperture 107, which usually lies at ground potential. The electron beam 104 may pass through a hole in the aperture 107 and enters the space behind, where no more acceleration takes place.

The magnetic coil 103 is provided outside the casing 108 (vacuum chamber), so that the vacuum atmosphere 109 inside the tube is not disturbed by a moving element.

As can be seen in FIG. 1, the electron beam 104 impinges the lower surface of the anode 102 which has, according to the described embodiment, a thickness of some millimetres. The X-rays 106 are emitted in the anode 102, and a sufficiently large amount of the X-rays is transmitted through the anode 102 to opt out of (i.e. to leave) an upper surface of the anode 102 (see FIG. 1). According to this transmission geometry using a relatively thin anode, it is advantageous to cool the anode, e.g. by providing a water cooling. Alternatively, the X-rays 106 reflected from the lower surface of the anode may be used. It this case, the X-rays would opt out of (i.e. leave) a lower surface of the anode 102. According to this reflection geometry, even a thicker anode may be used which may be cooled, e.g. by providing a water cooling. The anode will to be cooled in most cases. However, it is easier to establish when the X-rays are taken from the reflection side then from the transmission side.

In the following, referring to FIG. 2, an X-ray source apparatus 200 according to a second embodiment of the invention will be described.

The X-ray source apparatus 200 differs from the X-ray source apparatus 100 in that the movable magnetic coil 103 is replaced by a first fixed magnetic coil 201, a second fixed magnetic coil 202 and a third fixed magnetic coil 203 provided at different fixed positions along the propagation path of the incident electron beam 104. At each point of time, one particular of the fixed magnetic coil 201 to 203 which are unmovably provided along the propagation path of electron beam 104 is activated by applying an electric current of a predetermined strength and direction. Thus, in a particular operation state, one of the coils 201 to 203 is activated so that only one of the three coils 201 to 203 produces a magnetic field to deflect the electron beam 104 to the tungsten anode. The number of coils 201 to 203 used depends on the size of the anode 102 and on the desired focal spot positions. Although three coils 201 to 203 are shown in FIG. 2, a larger or smaller number of coils 201 to 203 may be selected.

Therefore, in case that only the first fixed magnetic coil 201 is activated by a current, a left part of the tungsten anode 102 is irradiated with the deflected electron beam 104. In case that only the second fixed magnetic coil 202 is provided with an electric current to produce a magnetic field, a middle part of the tungsten anode 102 is irradiated with an electron beam 104 to produce X-rays 106 in a middle portion of the anode 102. In a third case, in which an electric current is applied only to the third fixed magnetic coil 203 such that the third fixed magnetic coil 203 produces a magnetic field in a direction perpendicular to the paper plane of FIG. 2, the electron beam 104 is deflected in such a manner to impinge only at this right part of the anode 102 and to produce X-rays 106 only at this right part. Each of the coils 201 to 203 are provided outside the vacuum region 109 delimited by the casing 108.

In other words, the configuration of FIG. 2 shows an X-ray source apparatus 200 according to which the three coils 201 to 203 are provided as electron beam 104 deflection means arranged along the propagation path of the electron beam 104 coming from the cathode 101 such that the selectable irradiated part of the tungsten anode 102 is selectable by activating a single one of the magnetic coils 201 to 203 arranged along the propagation path of the incident electron beam 104. Each of the fixed magnetic coils 201-203 are provided unmovable.

Further, a manipulating coil 204 (a magnetic coil) is arranged between the cathode 101 and the magnetic coils 201 to 203, the manipulating coil 204 being arranged such that the propagation path of the incident electron beam 104 is slightly tilted with respect to an alignment direction along which the different selectable portions of the tungsten anode 102 are arranged. As can be seen from FIG. 2, the manipulating coil 204 can be supplied with a small electric current to produce a small magnetic field to slightly divert or diffract the electron beam 104 to deviate from the central axis, i.e. the horizontal axis according to FIG. 2.

The stationary manipulating coil 204 slightly tilts the electron beam 104 with some degrees of deviation from the horizontal axis before the electron beam 104 reaches the deflection coils 201 to 203. However, the deviation caused by the manipulating coil 204 is only a small “disturbation”, i.e. is much less than the deflection caused by one of the deflecting magnetic coils 201 to 203. In other words, coils 201 to 203 perform almost a 90° deflection, while the manipulating coil 204 in combination with one of the magnetic coils 201 to 203 performs a vernier adjustment of a position at which the electron beam 104 impinges on the anode 102, and thus defines the exact position at which the X-ray beam 106 is generated, allowing a fine tuning.

FIG. 2 shows a plurality of deflection paths of the electron beam 104 according to different operation states of the manipulating coil 204 and of the deflection coils 201 to 203.

In the following, referring to FIG. 3 and FIG. 4, diagrams 300, 400 are explained which compare the slight manipulation of the electron beam 104 as performed by the manipulation coil 204 (FIG. 3) with the deflection caused by one of the fixed magnetic coils 201 to 203 (FIG. 4).

FIG. 3 shows a diagram 300 having an abscissa 301 along which the horizontal direction of FIG. 2 is plotted in millimetres. Along an ordinate 302 of FIG. 3, the manipulation of the electron beam 104 in a direction perpendicular to the electron beam 104 in FIG. 2 is shown, caused by a small current flowing in the manipulating coil 204.

Diagram 400 of FIG. 4 plots along an abscissa 401 the horizontal direction of the apparatus 200 of FIG. 2, and plots along a vertical direction, i.e. along an ordinate 402, the vertical direction of FIG. 2, namely the deflection of the electron beam 104 caused by an activated deflection coil 201, 202, 203.

As can be seen from FIG. 3 and FIG. 4, the effect of the manipulating coil 204 is much smaller than the deflection effect of coils 201 to 203 shown in FIG. 4. According to FIG. 4, the deflection angle is almost 90°, and the deflection caused by the deflection coils 201 to 203 is significantly larger than the small manipulation of manipulating coil 204.

In the following, referring to FIG. 5, a baggage inspection computer tomography apparatus 500 according to a preferred embodiment of the invention will be described.

The computer tomography apparatus 500 comprises an X-ray source apparatus 501 which is similar to the X-ray source apparatus 100. FIG. 5 shows a first position of a movable coil 502 and a second position 503 of a movable coil, wherein by moving the movable coil, the region along the anode 102 at which X-rays 106 are emitted, can be controlled. By moving the movable coil from the first position 502 to the second position 503 (in a plurality of steps), a baggage object 502 as an object of interest to be examined can be scanned from left to right. The X-rays 106 which are irradiated on the baggage object 505 are scattered by material of and in the baggage object 505 and yield a characteristic scatter pattern which is detected by a two-dimensional X-ray detector 506. The X-ray detector 506 detects the scatter pattern of the baggage object 505 and forwards this data to a control computer 507. The control computer 507 determines from the measured scatter pattern an image of the material in the interior of the baggage object 505. In case that a suspicious material or a suspicious object is detected inside the baggage object 505, an alarm generator 509 generates an acoustical or optical alarm to indicate that the baggage object 505 is suspicious or dangerous. Thus, the baggage inspection computer tomography apparatus 500 can be used in an airport to determine whether baggage of the passengers of a plane is acceptable. Thus, weapons, explosives or other suspicious material can be detected.

As can be seen from FIG. 5, the baggage object 505 is located on a belt conveyor 504. This belt conveyor 504 may be driven by a belt conveyor control unit 508 which is controlled by the control computer 507. However, according to the invention, it is indispensable that the belt of the belt conveyor 504 is moved, since the baggage object 505 can be scanned in a direction from left to right according to FIG. 5 by moving the movable coil from the first position 502 to the second position 503, thus producing X-rays 106 to be emitted to a part of the baggage object 505, gradually from left to right.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

1. An X-ray source apparatus (100), comprising a cathode (101);
comprising an electron beam deflection means including one or more electron beam deflection elements (103);
comprising an anode (102);
wherein the cathode (101) is adapted to emit an electron beam (104) towards the electron beam deflection means;
wherein the electron beam deflection means is adapted to deflect an electron beam (104) coming from the cathode (101) to a selectable part (110) of the anode (102), wherein the selectable part (110) of the anode (102) is selectable by activating a single one of the one or more electron beam deflection elements (103), with the single activated electron beam deflection element (103) being arranged at a variable position along a propagation path of the electron beam (104) coming from the cathode (101), such that the electron beam (104) is deflected to the selectable part of the anode (102); and
wherein the anode (102) is adapted to generate an X-ray beam (106) when being irradiated by an electron beam (104) deflected by the electron beam deflection means.

2. X-ray source apparatus (100) according to claim 1, wherein at least one of the one or more electron beam deflection elements (103) is adapted to be movable along the propagation path of the electron beam (104) coming from the cathode (101).

3. X-ray source apparatus (200) according to claim 1, wherein the electron beam deflection means includes a plurality of electron beam deflection elements (201-203) arranged at different positions along the propagation path of the electron beam (104) coming from the cathode (101), and wherein the selectable part (110) of the anode (102) is selectable by activating a single one of the plurality of electron beam deflection elements (201-203) arranged at such a position along the propagation path of the electron beam (104) coming from the cathode (101), such that the electron beam (104) is deflected to the selectable part (110) of the anode (102).

4. X-ray source apparatus (200) according to claim 3, wherein the plurality of electron beam deflection elements (201-203) are provided unmovable at different positions along the propagation path of the electron beam (104) coming from the cathode (101).

5. X-ray source apparatus (100) according to claim 1, wherein the electron beam deflection means is adapted to deflect an electron beam (104) coming from the cathode (101) to a selectable part (110) of the anode (102) by a deflection angle of essentially 90°.

6. X-ray source apparatus (100) according to claim 1, wherein at least one of the at least one electron beam deflection elements (103) is a coil.

7. X-ray source apparatus (100) according to claim 6, wherein the axis of the coil is oriented perpendicular to a plane established by the propagation path of the electron beam (104) coming from the cathode (101) and by a propagation path of the electron beam (104) between the electron beam deflection means and the anode (102).

8. X-ray source apparatus (100) according to claim 1, which is adapted such that the propagation path of the electron beam (104) between the cathode (101) and the activated electron beam deflection element (103) is essentially linear.

9. X-ray source apparatus (100) according to claim 1, which is adapted such that the propagation path of the electron beam (104) between the cathode (101) and the activated electron beam deflection element (103) is essentially parallel to an alignment direction along which different selectable portions (110) of the anode (102) are arranged.

10. X-ray source apparatus (100) according to claim 1, comprising an aperture (107) between the cathode (101) and the electron beam deflection means.

11. X-ray source apparatus (100) according to claim 1, comprising a voltage supply adapted to bring the cathode (101) to a first electric potential and to bring the anode (102) to a second electric potential, the first electric potential being negative compared to the second electric potential.

12. X-ray source apparatus (100) according to claim 1, comprising a casing (108) in which the cathode (101) and the anode (102) are arranged, wherein at least a part of the electron beam deflection means is provided outside the casing (108).

13. X-ray source apparatus (100) according to claim 1, comprising an electron beam manipulating element (204) arranged between the cathode (101) and the electron beam deflection means, the electron beam manipulating element (204) being arranged such that the propagation path of the electron beam (104) coming from the cathode (101) is slightly tilted against an alignment direction along which different selectable portions (110) of the anode (102) are arranged.

14. A computer tomography apparatus (500) for examination of an object (505) of interest, the computer tomography apparatus (500) comprising;
an X-ray source apparatus (501) according to claim 1 for emitting X-rays to the object (505) of interest; and
a scatter radiation detector (506) for receiving X-rays (106) scattered by the object (505) of interest.

15. Computer tomography apparatus (500) according to claim 14, configured as one of the group consisting of a baggage inspection apparatus, a medical application apparatus, a material testing apparatus and a material science analysis apparatus.

16. A method of operating an X-ray source apparatus (100), comprising the steps of:
emitting an electron beam (104) towards an electron beam deflection means which includes one or more electron beam deflection elements (103);
deflecting the electron beam (104) by the electron beam deflection means to a selected part (110) of an anode (102), wherein the selected part (110) of the anode (102) is selected by activating a single one of the one or more electron beam deflection elements (103), with the single activated electron beam deflection element (103) being arranged at a variable position along a propagation path of the emitted electron beam (104), such that the electron beam (104) is deflected to the selectable part (110) of the anode (102); and
generating an X-ray beam (106) by irradiating the anode (102) by an electron beam (104) deflected by the electron beam deflection means.
